(19) United States
(12) Patent Application Publication
(10) Pub. No.: US 2005/0081238 A1
(43) Pub. Date: Apr. 14, 2005

(54) Video distribution system for viewers to view video programs without paying subscription fee and being annoyed by commercial messages during video programs

(76) Inventor: Kazuhiro Hara, Tokyo (JP)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/959,115

(22) Filed: Oct. 7, 2004

(30) Foreign Application Priority Data
Oct. 14, 2003 (JP) 2003-353476

(51) Int. Cl. H04N 7/16; H04N 7/025; H04N 5/445; G06F 3/00; H04N 7/10; H04H 9/00; H04N 7/173; G06F 13/00

(52) U.S. Cl. 725/35; 725/34; 725/9; 725/14; 725/109; 725/46

(57) ABSTRACT

A broadcasting station server distributes a video program and calculates a viewing time of each viewer who is viewing the video program. When the video program is finished, the broadcasting station server sends the user ID of the viewer who has viewed the video program and the viewing time thereof as viewing information through the Internet to a data center. The data center selects the user ID of a viewer whose viewing time of the video program is longer than a predetermined time from the received viewing information, and distributes advertisement information corresponding to the video program, together with a reception acknowledgment added thereto, to a mail address corresponding to the selected user ID. If the reception acknowledgment is not returned from the recipient of the advertisement information, the data center keeps on sending the advertisement information at predetermined time intervals until the reception acknowledgment is returned.

### BACKGROUND OF THE INVENTION

1. Field of the Invention

The present invention relates to a video distribution system and a video distribution method for distributing video programs through the Internet.

2. Description of the Related Art

With the rapid dissemination of the Internet, there has been proposed a distribution system for distributing video programs and music programs through the Internet, as disclosed in the following document 1:

Document 1: Japanese laid-open patent publication No. 2003-101498

Even video distribution systems for distributing video programs through the Internet require expenses for producing and distributing video programs, as with conventional broadcasting businesses for broadcasting video programs. For successfully establishing a business of video distribution, therefore, it is necessary to provide some means for recovering expenses entailed in producing and distributing video programs.

Conventional broadcasting businesses for broadcasting video programs have been present in the following three types:

(1) A broadcasting company raises funds for producing programs to be broadcast from sponsors, and produces programs with the raised funds, and viewers are not required to pay a subscription fee (Commercial broadcasting system).

(2) A broadcasting company collects subscription fees from viewers, and produces programs with the collected subscription fees (Government-run broadcasting system).

(3) A broadcasting company presents programs to be selected by viewers, and collects subscription fees from viewers for programs that are selected by the viewers (CATV system).

Of the above three systems, the commercial broadcasting system (1) does not require viewers to pay a subscription fee. However, the viewers of programs broadcast in the commercial broadcasting system have to see the programs that are frequently interrupted by commercial messages and view those commercial messages (advertisement) that the viewers actually do not want to see. Furthermore, sponsors judge whether viewers see commercial messages or not only based on the viewing rate, and are unable to determine whether viewers surely see commercial messages or not.

According to the systems (2) and (3), viewers need to pay a subscription fee, though they do not have to view commercial messages.

If one of the conventional broadcasting systems is applied to a video distribution system for distributing video programs through the Internet, then either commercial messages are inserted in video programs or subscription fees are collected from viewers.

According to such a video distribution system, the viewers need to select a mode in which commercial messages are viewed during video programs or a mode in which a subscription fee is paid to view video programs with no commercial messages inserted therein. There has been a demand for a video distribution system which allows viewers to be free of the need to see commercial messages during video programs and also to view video programs without paying a subscription fee.

One way of having viewers see advertisements is to distribute advertisements separately from video programs, rather than sending them by interrupting video programs. For example, the document 2 shown below discloses a commercial message production and distribution system for distributing broadcast commercial messages via electronic mail. The document 3 shown below discloses a video distribution system for recording a viewing log, analyzing the recorded viewing log, and automatically distributing advertisement contents that are optimum for the analyzed viewing log.

Document 2: Japanese laid-open patent publication No. 2003-058465

Document 3: Japanese laid-open patent publication No. 2002-149693

The above video conventional distribution systems analyze the preference of users and distribute advertisement contents that are effective for the preference of users. These systems merely employ the viewing log to analyze the preference of users, and do not distribute advertisement contents related to the viewing of video programs.

The above conventional video distribution systems cannot dispense with the payment of subscription fees for viewing video programs and commercial messages inserted in video programs. Therefore, the viewers still need to select either the mode to view commercial messages during video programs or the mode to pay a subscription fee to see video programs that are feed of commercial messages.

### SUMMARY OF THE INVENTION

It is an object of the present invention to provide a video distribution system, a video distribution method, and a program for allowing viewers to be free of the need to see commercial messages during video programs and also to view video programs without paying a subscription fee.

To achieve the above object, a video distribution system for distributing video programs through the Internet according to the present invention has a broadcasting station server and a data center.

The broadcasting station server has a viewing time database, a viewing time manager, and a viewing information transmitter.

The viewing time database records, in association with the user ID of each viewer, a viewing start time, a viewing stop time, and a viewing time of each viewer who views a video program, for each of video programs that are distributed by the broadcasting station server.

When the viewer's terminal gains access to the broadcasting station server vie the Internet and starts viewing the video program that is being distributed, the viewing time manager records the user ID of the viewer and a viewing start time thereof in the viewing time database. When a signal indicative of the stoppage of viewing of the video program is received from the viewer's terminal that views the video program, the viewing time manager calculates a viewing time from the difference between a viewing stop time included in the signal and the viewing start time recorded in the viewing time database, and records the calculated viewing time in the viewing time database.

When program end information indicative of the end of the distributed video program is received, the viewing information transmitter transmits the user ID and a viewing time of the viewer who has viewed the video program as viewing information through the Internet.

The data center has a mail address database, an. advertisement information database, a decision unit, and an advertisement mail distributor.

The mail address database stores the user IDs of viewers and mail addresses thereof in one-to-one correspondence. The advertisement information database stores prepared advertisement information for each of video programs.

The decision unit selects the user ID of a viewer whose viewing time of the video program is longer than a predetermined time from the viewing information transmitted from the broadcasting station server via the Internet.

The advertisement mail distributor reads a mail address corresponding to the user ID selected by the decision unit from the mail address database. The advertisement mail distributor reads advertisement information corresponding to the video program from the advertisement information database, and distributes an advertisement mail to which the advertisement information read from the advertisement information database is added to the mail address read from the mail address database.

With the video distribution system according to the present invention, the viewer may view a video program free of commercial messages as much as they like and may view an advertisement mail that is sent after the viewing of the video program at any time they like. Therefore, the viewer can view a video program without paying a subscription fee and also without being annoyed by commercial messages during the video program.

The sponsor of the video program can accurately recognize who has viewed the video program and how long the viewer has viewed the video program, and can reliably send an advertisement to the viewer.

The broadcasting station which distributes video programs can send questionnaires to viewers who have actually viewed video programs, receive answers thereto, and can produce new video programs accurately reflecting the opinions of the viewers from the received answers.

When the advertisement mail distributor distributes the advertisement information read from the advertisement information database, the advertisement mail distributor also distributes a reception acknowledgment added to the advertisement information. If the reception acknowledgment is not returned from the mail address, the advertisement mail distributor may keep on transmitting the advertisement information at predetermined time intervals until the reception acknowledgment is returned from the mail address.

According to the present invention, the advertisement distributor can reliably send an advertisement to the viewer by confirming that the viewer has viewed by advertisement mail based on the reception acknowledgment.

The above and other objects, features, and advantages of the present invention will become apparent from the following description with reference to the accompanying drawings which illustrate an example of the present invention.

### BRIEF DESCRIPTION OF THE DRAWINGS

FIG. 1 is a block diagram of a video distribution system according to an embodiment of the present invention;

FIG. 2 is a block diagram of a broadcasting station server in the video distribution system shown in FIG. 1;

FIG. 3 is a diagram showing an example of data stored in a viewing time DB in the broadcasting station server shown in FIG. 2;

FIG. 4 is a block diagram of a data center in the video distribution system shown in FIG. 1;

FIG. 5 is a diagram showing an example of data stored in a mail address DB in the data center shown in FIG. 4; and

FIG. 6 is a diagram showing an operation sequence of the video distribution system according to the embodiment of the present invention.

### DETAILED DESCRIPTION OF THE PREFERRED EMBODIMENT

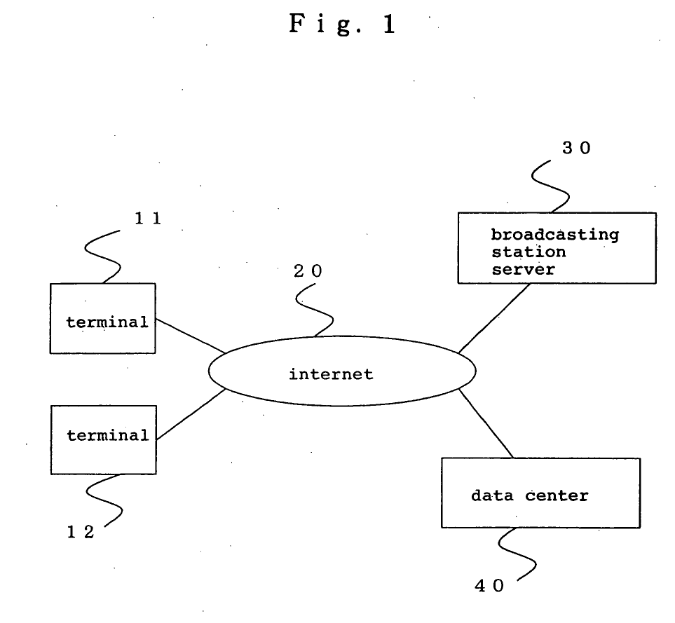

FIG. 1 shows in block form a video distribution system according to an embodiment of the present invention.

As shown in FIG. 1, the video distribution system according to the embodiment comprises viewer's terminals 11, 12, a broadcasting station server 30, and a data center 40 which are connected to each other through the Internet 20. Although only two viewer's terminals 11, 12 are illustrated for the sake of brevity, the video distribution system actually has a number of viewer's terminals.

A software program for distributing video programs is installed in each of the viewer's terminals 11, 12. When a user stops viewing a video program, the software program transmits a signal indicative of the stoppage of the viewing of the video program and a viewing stop time through the Internet 20 to the broadcasting station server 30.

The broadcasting station server 30 shown in FIG. 1 is illustrated in detail in FIG. 2. As shown in FIG. 2, the broadcasting station server 30 has a viewing time manager 31, a viewing information transmitter 32, and a viewing time database (DB) 33. For the sake of brevity, an arrangement for distributing video programs in the broadcasting station server 30 is omitted from illustration.

The viewing time database (DB) 33 records, in association with the user ID of each viewer, a viewing start time, a viewing stop time, and a viewing time of each viewer who views a video program, for each of video programs that are distributed by the broadcasting station server 30.

When each of the viewer's terminals 11,12 gains access to the broadcasting station server 30 vie the Internet 20 and starts viewing a video program that is being distributed, the viewing time manager 31 records the user ID of the viewer and the viewing start time thereof in the viewing time DB 33. When the viewing time manager 31 receives a signal indicative of the stoppage of viewing of the video program from each of the viewer's terminals 11,12 that views the video program, the viewing time manager 31 calculates a viewing time from the difference between a viewing stop time included in the signal and the viewing start time recorded in the viewing time DB 33, and records the calculated viewing time together with the viewing stop time in the viewing time DB 33.

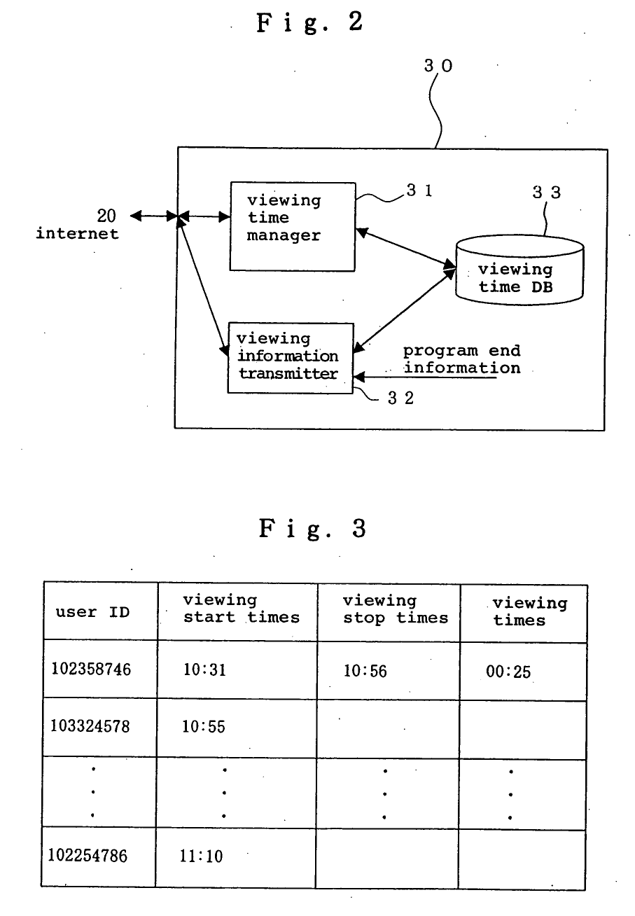

An example of data stored in the viewing time DB 33 is shown in FIG. 3. As shown in FIG. 3, the viewing time DB 33 records therein user IDs, viewing start times, viewing stop times, and viewing times in association with each other. The viewing time represents a time from a viewing start time to a viewing stop time, i.e., a time during which the viewer has seen a video program. For example, a viewer whose user ID is “102358746” starts viewing a video program at 10:31 and stops viewing the video program at 10:56, and hence has a viewing time of 25 minutes.

When the viewing information transmitter 32 receives program end information indicative of the end of a distributed video program, the viewing information transmitter 32 transmits the user ID and the viewing time of a viewer who has viewed the video program as viewing information through the Internet 20 to the data center 40.

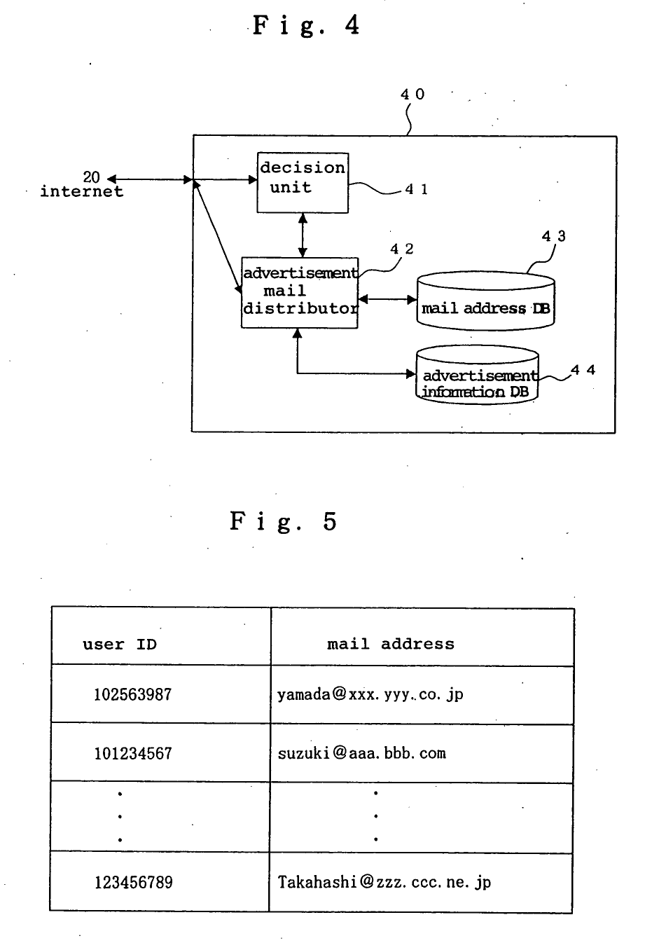

The data center 40 shown in FIG. 1 is illustrated in detail in FIG. 4. As shown in FIG. 4, the data center 40 comprises a decision unit 41, an advertisement mail distributor 42, a mail address database (DB) 43, and an advertisement information database (DB) 44.

The mail address database (DB) 43 stores the user IDs of viewers who intend to accept the distribution of video programs and mail addresses thereof in one-to-one correspondence. A viewer who is going to accept the distribution of video programs is required to report its own mail address in advance as a condition for using the video distribution system. The mail addresses of those viewers are stored in the mail address DB 43.

An example of data stored in the mail address DB 43 is shown in FIG. 5. As shown in FIG. 5, the mail address DB 43 records therein the user IDs of viewers and mail addresses thereof in association with each other.

The advertisement information database (DB) 44 stores advertisement information of prepared moving images for each of the video programs.

The decision unit 41 selects the user ID of a viewer whose viewing time of the video program is longer than a certain time (e.g., 30 minutes for a 1-hour video program) from viewing information transmitted from the broadcasting station server 30 via the Internet 20, and transmits the selected user ID together with information indicative of the video program to the advertisement mail distributor 42.

The advertisement mail distributor 42 reads a mail address corresponding to the user ID sent from the decision unit 41 from the mail address DB 43, and also reads advertisement information of a moving image corresponding to the video program that is identified from the information sent from the decision unit 41, from the advertisement information database (DB) 44. The advertisement mail distributor 42 distributes an advertisement mail with a reception acknowledgment, to which the advertisement information of the moving image read from the advertisement information database (DB) 44 is added, to the mail address read from the mail address DB 43.

If the reception acknowledgment is not transmitted from the viewer's terminal to which the advertisement mail is distributed, then the advertisement mail distributor 42 sends the advertisement mail again to that viewer's terminal. If the viewer's terminal still does not return the reception acknowledgment, then the advertisement mail distributor 42 keeps on transmitting the advertisement mail at certain time intervals until the reception acknowledgment is sent back.

A single process for a viewer to start viewing a video program, and a single process for a viewer to stop viewing a video program have been described above. If a viewer stops viewing a video program and thereafter starts viewing the same video program again, then times for which the same viewer has seen the video program are accumulated, and the sum of the accumulated times is regarded as a viewing time. In this case, the viewing time manager 31 of the broadcasting station server 30 leaves only the information of the viewing time corresponding to the user ID of the viewer in the viewing time DB 33, resets the viewing start time and the viewing stop time, and records a time when the viewer starts viewing the video program again as the viewing start time. When the viewer thereafter stops viewing the video program, the viewing time manager 31 adds the second viewing time to the previous viewing time, and records the sum of the viewing times as a new viewing time in the viewing time DB 33.

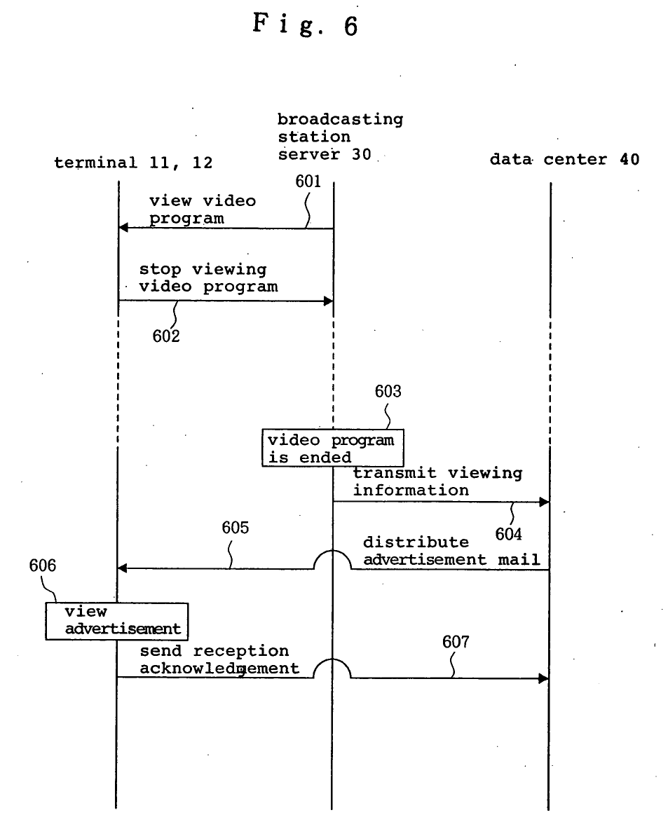

Operation of the video distribution system according to the present embodiment will be described in detail below. An operation sequence of the video distribution system according to the present embodiment is shown in FIG. 6.

In step S601, a viewer gains access to the broadcasting station server 30 through the viewer's terminal 11, 12 to view a video program. When the viewer stops viewing the video program in step 602, a signal indicative of the stoppage of viewing of the video program, together with the viewing stop time, from the viewer's terminal 11, 12 via the Internet 20 to the viewing time manager 31 in the broadcasting station server 30. In the broadcasting station server 30, the viewing time manager 31 calculates a viewing time of the viewer and stores the calculated viewing time in the viewing time DB 33.

In step 603, the video program is ended and program end information is supplied to the video information transmitter 32 in the broadcasting station server 30. In step 604, the video information transmitter 32 transmits the user ID of the viewer who has viewed the video program and the viewing time as viewing information through the Internet 20 to the data center 40.

When the viewing information from the broadcasting station server 30 is supplied to the data center 40, the decision unit 41 selects the user ID of a viewer whose viewing time of the video program is longer than a certain time (e.g., 30 minutes for a 1-hour video program) from the supplied viewing information, and transmits the selected user ID together with information indicative of the video program to the advertisement mail distributor 42. In step 605, the advertisement mail distributor 42 distributes an advertisement mail with a reception acknowledgment, to which the advertisement information of the moving image is added, to the mail address corresponding to the user ID sent from the decision unit 41.

In step 606, the viewer whose has received the advertisement mail from the viewer's terminal 11, 12 views the advertisement at any desired time. When the viewing of the advertisement is over, the viewer's terminal 11, 12 sends the reception acknowledgment to the data center 40 in step 607. In response to the reception of the reception acknowledgment from the viewer's terminal 11, 12, the data center 40 confirms that the viewing of the advertisement mail transmitted by the advertisement mail distributor 42 is finished, and puts an end to the operation sequence. If the reception acknowledgment is not sent from the viewer's terminal 11, 12, then the advertisement mail distributor 42 sends the advertisement mail again to the viewer's terminal 11, 12. For example, if the reception acknowledgment is not returned from the viewer's terminal 11, 12, then the advertisement mail distributor 42 automatically resends the advertisement mail each time one day elapses until the reception acknowledgment is received.

With the video distribution system according to the present embodiment, the viewer may view a video program free of commercial messages as much as they like and may view an advertisement mail that is sent after the viewing of the video program at any time they like. Therefore, the viewer can view a video program without paying a subscription fee and also without being annoyed by commercial messages during the video program.

The sponsor of the video program can accurately recognize who has viewed the video program and how long the viewer has viewed the video program, and can reliably send an advertisement to the viewer by confirming that the viewer has viewed by advertisement mail based on the reception acknowledgment.

The broadcasting station which distributes video programs can send questionnaires to viewers who have actually viewed video programs, receive answers thereto, and can produce new video programs accurately reflecting the opinions of the viewers from the received answers.

In the illustrated embodiment, video programs are distributed. However, the present invention is also applicable to a system of distributing other contents such as music programs or the like.

Although not shown, the broadcasting station server 30 and the data center 40 in the video distribution system according to the present embodiment have a recording medium which stores a program for executing the video distribution method described above. The program is read from the recording medium into the broadcasting station server 30 and the data center 40 to control operation of the video distribution system. Specifically, CPUs in the broadcasting station server 30 and the data center 40 are controlled by the program to instruct hardware resources in the broadcasting station server 30 and the data center 40 to perform certain processing sequences, thereby carrying out the process described above.

While a preferred embodiment of the present invention has been described using specific terms, such description is for illustrative purposes only, and it is to be understood that changes and variations may be made without departing from the spirit or scope of the following claims.

1. A video distribution system for distributing video programs through the Internet, comprising:
a broadcasting station server having a viewing time database recording, in association with a user ID of each viewer, a viewing start time, a viewing stop time, and a viewing time of each viewer who views a video program, for each of video programs that are distributed by the broadcasting station server, a viewing time manager for, when a viewer's terminal gains access to the broadcasting station server vie the Internet and starts viewing the video program that is being distributed, recording the user ID of the viewer and a viewing start time thereof in said viewing time database, and for, when a signal indicative of a stoppage of viewing of the video program is received from the viewer's terminal that views the video program, calculating a viewing time from a difference between a viewing stop time included in said signal and the viewing start time recorded in said viewing time database, and for recording the calculated viewing time in said viewing time database, and a viewing information transmitter for, when program end information indicative of an end of the distributed video program is received, transmitting the user ID and a viewing time of the viewer who has viewed the video program as viewing information through the Internet; and
a data center having a mail address database storing the user IDs of viewers and mail addresses thereof in one-to-one correspondence, an advertisement information database storing prepared advertisement information for each of video programs, a decision unit for selecting the user ID of a viewer whose viewing time of the video program is longer than a predetermined time from the viewing information transmitted from said broadcasting station server via the Internet, and an advertisement mail distributor for reading a mail address corresponding to the user ID selected by said decision unit from said mail address database, reading advertisement information corresponding to the video program from said advertisement information database, and distributing an advertisement mail to which the advertisement information read from said advertisement information database is added to the mail address read from said mail address database.

2. A video distribution system according to claim 1, wherein said advertisement mail distributor distributes the advertisement information read from said advertisement information database, together with a reception acknowledgment, to the mail address read from said mail address database, and if the reception acknowledgment is not returned from said mail address, keeps on transmitting the advertisement information at predetermined time intervals until the reception acknowledgment is returned from said mail address.

3. A method of distributing video programs through the Internet, comprising the steps of:
when a viewer's terminal gains access through the Internet and starts viewing a video program that is distributed, recording the user ID of the viewer and a viewing start-time in a viewing time database;
when a signal indicative of the stoppage of viewing of the video program is received from the viewer's terminal that views the video program, calculating a viewing time from the difference between a viewing stop time included in said signal and the viewing start time recorded in said viewing time database, and recording the calculated viewing time in said viewing time database;
when program end information indicative of the end of the distributed video program is received, transmitting the user ID and a viewing time of the viewer who has viewed the video program as viewing information;
selecting the user ID of a viewer whose viewing time of the video program is longer than a predetermined time from the viewing information that is transmitted; and
distributing an advertisement mail to which advertisement information corresponding to the video program is added to the selected mail address.

4. A method according to claim 3, wherein said step of distributing an advertisement mail includes the steps of distributing the advertisement information together with a reception acknowledgment, and if the reception acknowledgment is not returned from said mail address, keeping on transmitting the advertisement information at predetermined time intervals until the reception acknowledgment is returned from said mail address.

5. A program for enabling a computer to perform a method of distributing video programs through the Internet, comprising the processes of:
when a viewer's terminal gains access through the Internet and starts viewing a video program that is distributed, recording the user ID of the viewer and a viewing start time in a viewing time database;
when a signal indicative of the stoppage of viewing of the video program is received from the viewer's terminal that views the video program, calculating a viewing time from the difference between a viewing stop time included in said signal and the viewing start time recorded in said viewing time database, and recording the calculated viewing time in said viewing time database;
when program end information indicative of the end of the distributed video program is received, transmitting the user ID and a viewing time of the viewer who has viewed the video program as viewing information;
selecting the user ID of a viewer whose viewing time of the video program is longer than a predetermined time from the viewing information that is transmitted; and
distributing an advertisement mail to which advertisement information corresponding to the video program is added to the selected mail address.

6. A program according to claim 5, wherein said process of distributing an advertisement mail enables the computer to perform the processes of distributing the advertisement information together with a reception acknowledgment, and if the reception acknowledgment is not returned from said mail address, keeping on transmitting the advertisement information at predetermined time intervals until the reception acknowledgment is returned from said mail address.
